(19) United States
(12) Patent Application Publication
(10) Pub. No.: US 2016/0157100 A1
(43) Pub. Date: Jun. 2, 2016

(54) MOBILE-DEVICE SECURITY

(71) Applicant: TROLMENS GÅRD AB, Hälekis (SE)

(72) Inventor: Olof SODERBLOM, Hälekis (SE)

(21) Appl. No.: 14/904,246

(22) PCT Filed: Jul. 14, 2014
(86) PCT No.: PCT/GB2014/000284

§ 371 Date: Jan. 11, 2016

(30) Foreign Application Priority Data
Jul. 12, 2013 (GB) 1312557.0
Jul. 15, 2013 (GB) 1312643.8
Jul. 24, 2013 (GB) 1313237.8
Aug. 8, 2013 (GB) 1314211.2
Nov. 12, 2013 (GB) 1319962.5
Mar. 6, 2014 (GB) 1403992.9
May 30, 2014 (GB) 1409680.4

(51) Int. Cl. H04W 12/08; H04W 12/12; H04W 4/02

(52) U.S. Cl. CPC H04W 12/08; H04W 4/025; H04W 12/12

(57) ABSTRACT

A method and system for affording security to a mobile phone (1) or other mobile device that involves checks by the device (1) on reception of a code transmitted repeatedly to it from a transmitter unit (8) of a transponder (7) that is interrogated by the device (1) and carried nearby the device-user. The absence of reception of the code by the device (1) resulting from theft or other loss separating it out of range from the transponder (7), together with detection of device-movement results in an alarm which if, not acted on causes, the device (91) to enter a lock-down mode in which it cannot be turned off without entry of a correct password or other person-identifier. In this mode, operation of the device is restricted to transponder-interrogation, GPS or other tracking, and server communication via the internet (3) enabling its location to be determined.

This invention relates to mobile-device security, and in this respect is concerned with security of mobile devices such as cell phones, tablets and other personal digital-assistant devices, in the event of theft and/or accidental loss.

Mobile devices are now sophisticated computers, and are increasingly used to access password-protected sites and enterprise databases, with the devices performing log-on and database-search functions with a minimum of user-intervention. Sensitive data is normally stored on a mobile device of this kind, and theft and accidental loss of the device can leave the rightful user not only bereft of a crucial facility but also vulnerable to fraud.

It is an object of the present invention to provide a method and system that affords security to a mobile device in the event of theft and/or accidental loss.

According to one aspect of the present invention there is provided a method for affording security to a mobile device wherein a code-transmitting unit and the mobile device are independently moveable relative to one another, and the code-transmitting unit is operative to transmit a code repeatedly for reception by the mobile device subject to limitation of transmission range from the code-transmitting unit to the mobile device, and wherein one or more operations of the mobile device are inhibited or activated in the event that the transmitted code is not received by the mobile device.

According to another aspect of the invention a security system comprises a mobile device and a code-transmitting unit that are moveable independently of one another, wherein the code-transmitting unit is operable to transmit a code repeatedly for reception by the mobile device subject to limitation of transmission range from the code-transmitting unit to the mobile device, and wherein at least one or more operations of the mobile device are inhibited or activated in the event that the transmitted code is not received by the mobile device.

The transmitted code of both aspects of the invention specified above may be stored with the code-transmitting unit, and may include at least a component that is distinctive of the code-transmitting unit for detection by the mobile device. The code may be derived from a signal received by the code-transmitting unit from the mobile device.

The code-transmitting unit may be part of a transponder, and in these circumstances the transmitted code may be derived from a signal received by the transponder from the mobile device. More especially, and according to a feature of the invention, there is provided a method for affording security to the mobile device wherein the mobile device acts to interrogate the transponder repeatedly, the transponder is operative to transmit the code for reception by the mobile device in response to each successive interrogation of the transponder by the mobile device, and wherein at least one or more operations of the mobile device are inhibited or activated in the event that the code is not received by the mobile device from the transponder. Furthermore, according to a further feature of the invention there is provided a security system comprising the mobile device and the transponder, wherein the mobile device is operable to interrogate the transponder repeatedly, the transponder is operative to transmit a code for reception by the mobile device in response to each successive interrogation of the transponder by the mobile device, and wherein at least one or more operations of the mobile device are inhibited or activated in the event that the code is not received by the mobile device from the transponder.

Communications between the mobile device and the transponder or other code-transmitting unit, which, for example, may be implemented using Bluetooth protocols, may be limited to a short range of, say, just a few metres or less. Separation by more than this between the mobile device and the transponder or other code-transmitting unit, as is most likely in the event of theft, or even loss, of the mobile device will result at least in some reduction in the capability of the mobile device by inhibiting or activating one or more operations of the mobile device

One of the operations of the mobile device that may be inhibited in the event of failure to receive the transmitted code, is importantly that of turning the mobile device off. This has the advantage that if the mobile device is stolen, the thief, without materially damaging the mobile device cannot readily stop operations of the device within, for example, a cellular wireless network to which it belongs, that may be used remotely to reveal (at least approximately) the geographical location of the mobile device. In this respect, the device may incorporate specific functionality for GPS tracking purposes, but in any event its Location can be revealed by reference geographically to the base stations with which it is in communication within the cellular wireless network, such that any movement of the device from cell to cell can be tracked by reference to change of base stations.

The possibility with the method and system of the present invention of turning the mobile device off may be subject solely to reception of the transmitted code, but it may instead be subject to reception of the transmitted code or of entry of some form of security-checked password, or recognition and confirmation of one or more person-identifiers such as for example fingerprints, voice or other biometric characteristics of the authentic user. Where a password is to be entered this may be checked for correspondence with data stored in the mobile device; entry of the same or of a different password may be required for initiation of operation of the mobile device, and where password-entry is required for both turning off and initiation of operation, the password or passwords required may, for example, be hard-coded in the CPU of the device, or may be stored on a SIM card (Subscriber Identity Module) in the device, provided that security cannot be circumvented by replacing the card with another. Furthermore, or alternatively, the mobile device may automatically detect or be otherwise responsive to the condition in which there has been a change of user through lack of detection of one or more relevant person-identifiers, or of a significant change of environment.

In the circumstances in which the mobile device has been stolen, it can be assumed that it will be moved and that as a consequence there will be change of its GPS coordinates together with a related change of the base stations with which the mobile device is in wireless communication, and/or detection of movement by one or more accelerometers in the mobile device. Additionally, communication between the mobile device and the transponder or other code-transmitting unit will be lost, so detection of this condition in conjunction with detection of movement through change of GPS coordinates and/or base-station change or detection of movement by accelerometers in the mobile device, can be assumed to indicate that the device has been stolen. By arranging that a password used to initiate operation of the mobile device, or a different password, and/or recognition of one or more person-identifiers (such as for example fingerprints, voice or other biometric characteristics), is required to be used to terminate operation of the device, the thief will in normal circumstances be unable to turn off those functions which are active in operation of the device to enable its exact or approximate geographic location to be determined or tracked remotely from the device.

More especially, the method and system of the invention may include provision for responding to circumstances in which the mobile device detects that there has been a change of a predetermined amount in its GPS coordinates, or that a base station with which it has cellular wireless communication has changed, to sound an alarm and after a predetermined time place the mobile device in a lock-down mode in which, for example, operation of the mobile device is limited to checking: (a) for reception of the transmitted code; (b) for correspondence between a password keyed into the device and a password stored in the device, and/or recognition of one or more person-identifiers; and (c) the functioning of a GPS tracking or other facility that enables the location of the device to be determined or tracked remotely.

With both the method and system of the present invention, the code transmitted repeatedly by the transponder or other code-transmitting unit may be derived from a signal it receives from the mobile device, but alternatively may be hard-wired or otherwise stored in the transponder or other code-transmitting unit. More particularly, the transmitted code may be representative of code which is stored with the code-transmitting unit having been communicated to it from the mobile device, but may differ from the communicated code in some predetermined manner that is taken into account in determining whether a required correspondence exists. On the other hand, where the transmitted code is hard-wired or otherwise stored, it may at least include a component that is distinctive of the transponder or other code-transmitting unit, for detection by the mobile device.

A method according to the present invention for affording security to a mobile device, and a security system according to the invention, will now be described, by way of example, with reference to the accompanying drawings, in which:

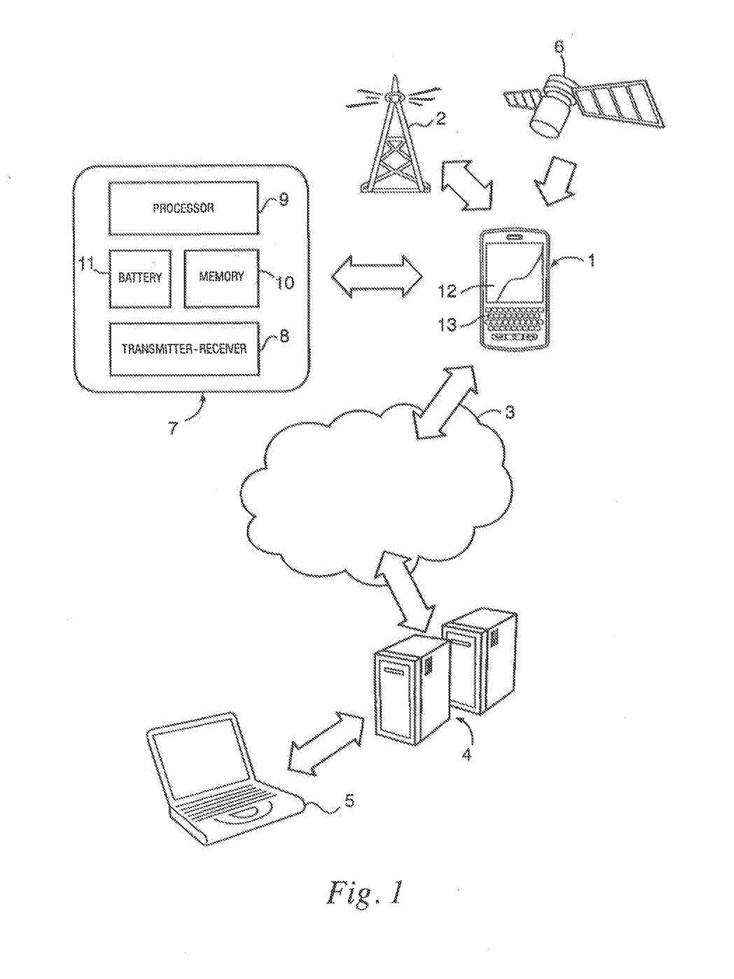

FIG. 1 is a schematic representation of an environment which includes a security system formed by the combination according to the present invention of a mobile device and a transponder;

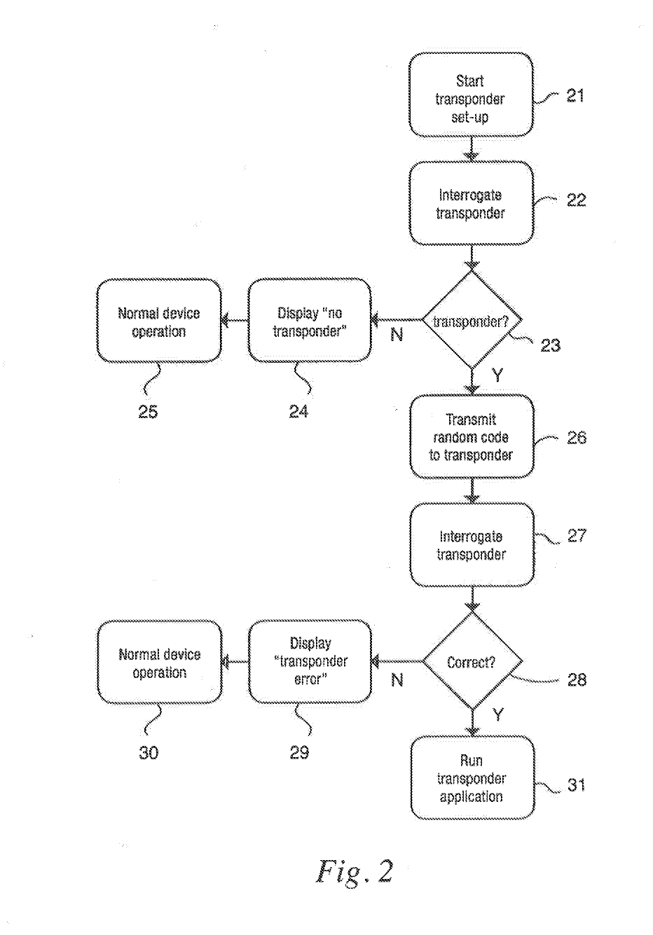

FIG. 2 is a flow-diagram illustrative of initial steps in operation of the mobile device in activation of a ‘transponder application’ involving interrogation of the transponder of the security system of FIG. 1;

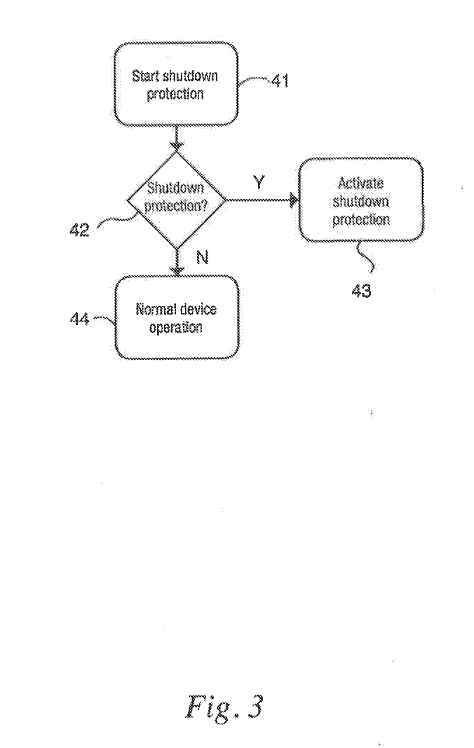

FIG. 3 is a flow-diagram illustrative of steps in activating ‘shutdown protection’ of the mobile device;

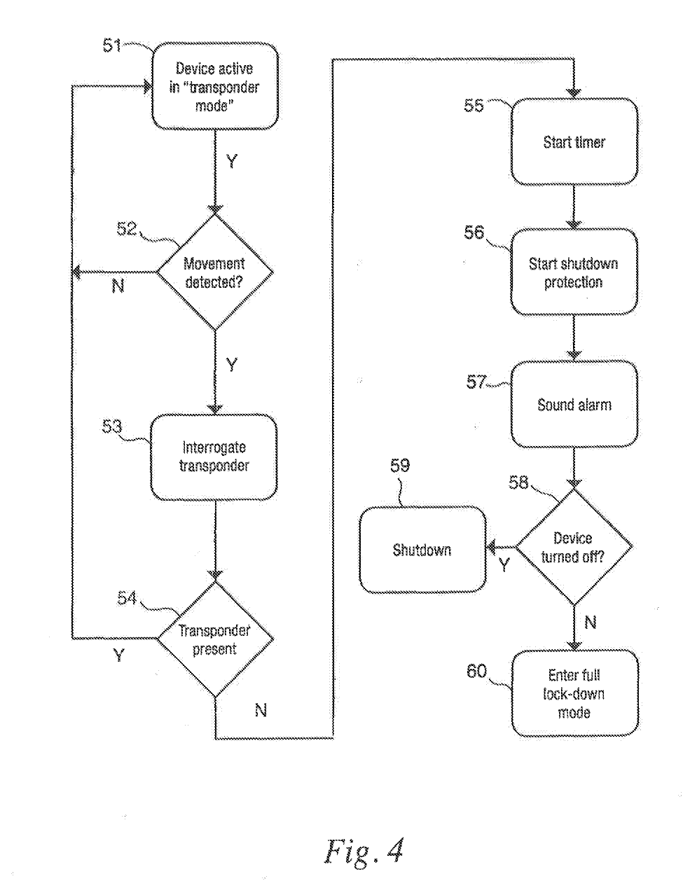

FIG. 4 is a flow-diagram illustrative of steps of operation of the security system in circumstances arising from separation of the mobile device from the transponder, as would indicate theft of the mobile device;

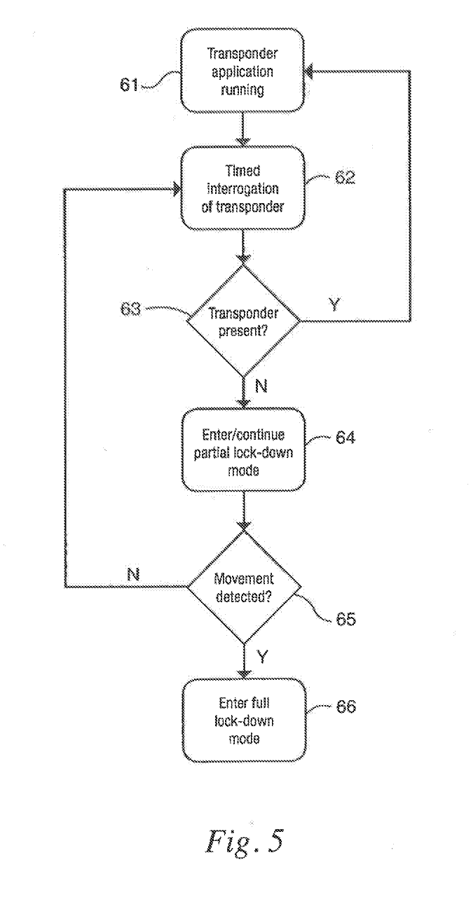

FIG. 5 is a flow diagram illustrative of steps of operation of the security system in circumstances arising from loss of the mobile device as well as subsequent theft thereof;

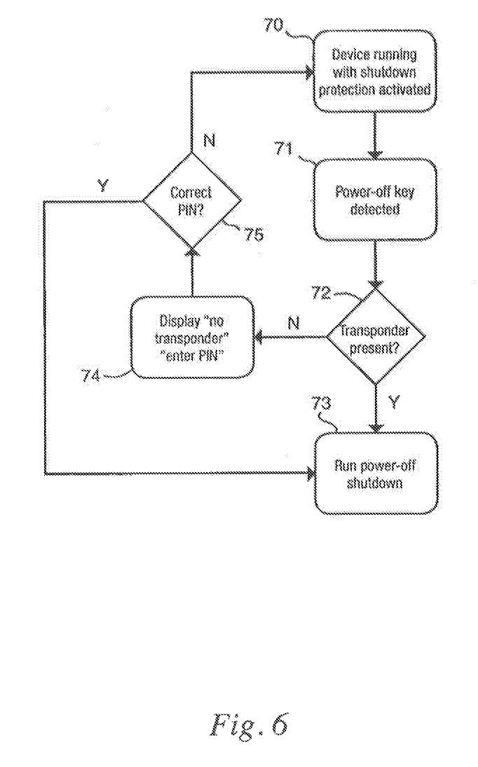

FIG. 6 is a flow-diagram illustrative of steps of operation in circumstances when the power-off key of the mobile device is depressed and a ‘shutdown protection’ application is active but the device is not in ‘lock-down’;

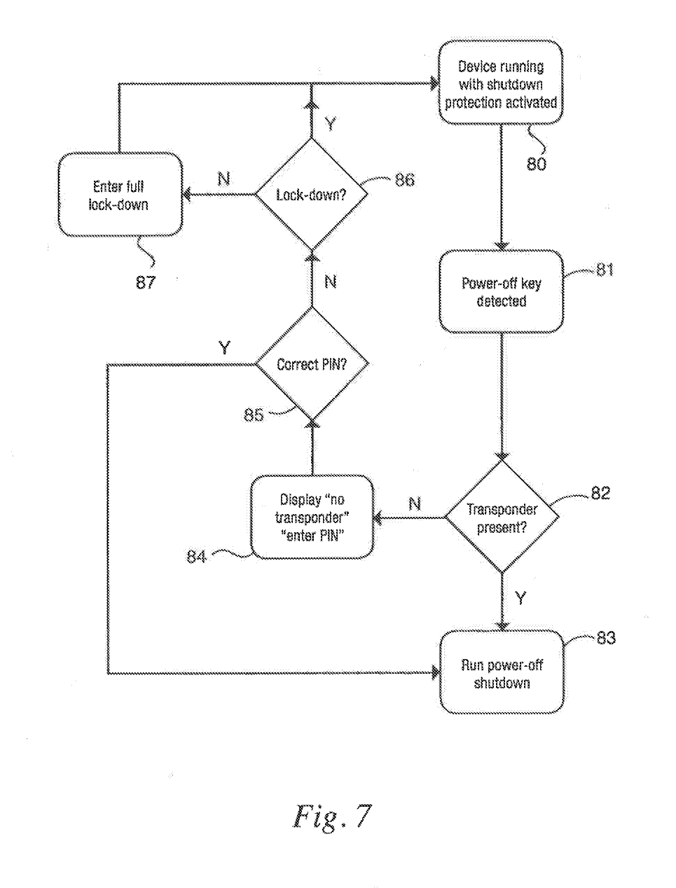

FIG. 7 is a modification of the flow-diagram of FIG. 6 for use in circumstances when the power-off key of the mobile device is depressed while the ‘shutdown protection’ application is running, the mobile device is in ‘lock-down’ mode, but not in the ‘full lock-down’; and

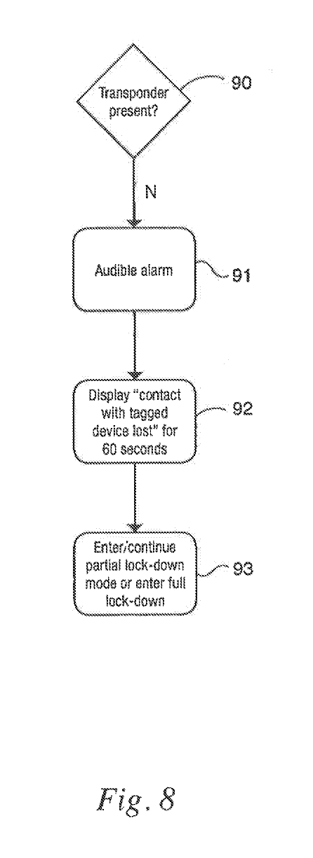

FIG. 8 is a partial flow-diagram illustrative of steps in response to loss or theft of a device incorporating the transponder function.

Referring to FIG. 1, the system includes a mobile device 1 which is illustrated as a cell phone, but which may be any mobile device, for example a smartphone, a tablet, or a wearable device. The device 1 is in two-way communication in the normal way with base stations 2 (only one shown) of a cellular wireless communications network, with the internet 3 and associated servers 4 and attached computer 5, and is also equipped to operate with a GPS satellite system 6. To this extent, the device 1 is conventional, but in accordance with the present invention it is also adapted for very short-range (for example, a few metres or less) two-way communication with a transponder 7. Furthermore, the device 1 desirably includes a back-up battery to its normal internal battery that, for example, is incorporated in the structure of the mobile device, so as not to be accessible without mutilation of the device 1.

The transponder 7 may have the general form and size of a credit card or key-ring fob, and may be included in a wearable device or other object that is capable of being readily carried in a pocket, in the form of a wrist-watch, or otherwise on the person of the user of the mobile device 1. It incorporates a transmitter/receiver unit 8 and integrated circuitry that involves a processor 9 and memory 10, all powered by a re-chargeable battery 11 or through the energy of interrogation signals received from the mobile device 1.

The mobile device 1, which has a conventional display screen 12 and keys 13 (a physical key-pad is illustrated but the keys may be virtual), includes the normal memory (not shown) as well as circuitry and software to support interrogation of the transponder 7 as well as reception of responses from it. This is in addition to the software and normal functionality required of the device 1 for communications with the base stations 2, the internet 3 and associated servers 4 and the GPS system 6. The functions of the device 1 in conjunction with the transponder 7, and in relation to shutdown protection are carried out by two applications that are running or can be caused to run in a multitasking environment in the mobile device 1, namely a “transponder application” and a “shutdown protection application”, respectively.

Operation of the mobile device 1 to run the transponder application for supporting interrogation of the transponder 7 and reception of responses from it, will now be described with reference to the flow-diagram of FIG. 2.

Referring to FIG. 2, the transponder application can be activated in step 21 at any time when the mobile device 1 is operating, by touching the relevant icon on the screen 12 of the mobile device 1, or through corresponding voice-activation by speech input. Activation of the transponder application is however subject to a limitation for security purposes, in that it can take place only once during any period of continuous operation of the mobile device, so that the device is unresponsive to touching of the relevant icon or the corresponding speech input unless the device 1 has been turned off since an immediately-preceding activation of the transponder application.

As described below, the transponder application is used in conjunction with a security measure that is effective to preclude a thief (who is assumed to be unable to satisfy password-security or person-identifier requirements of the rightful user) from switching the device off in the absence of reception by the device 1 of response from the transponder 7. The limit against repeated activation of the transponder application during any period of continuous operation of the device 1, protects against the thief being able to circumvent this security measure by using a similar transponder or otherwise, to reproduce the required transponder-responses.

When there is successful activation of the transponder application via step 21, the mobile device 1 acts via step 22 to initiate two-way communication with the transponder 7. This is by means of transmission from the device 1 of a low-power signal, for example representative of code 1234 (on a frequency which may be generally allocated, or which is specifically allocated to the transponder). The low-power transmission is such that it will be received by the transponder 7 only if the transponder 7 is within a prescribed short range of the device 1. In the event that the code is received by the transponder 7, the transponder 7 acknowledges reception by transmitting a response (which may be the same as the interrogation code 1234) to the device 1. The transmission is made at the low power applicable to short-range reception, such as according to the Bluetooth protocol, and is accompanied by a warning signal if charge of the battery 11 is low.

The device 1 determines in decision step 23 whether the response is received from the transponder 7. If the response is not received, this situation is displayed on the screen 12 of the device 1 in step 24, and results in a step 25 closing the transponder application and causing the mobile device 1 to revert to its normal operation without proceeding with the transponder application.

In the event that the device 1 determines at step 23 that the response from the transponder 7 is received, it initiates generation of a random code; if a warning signal that charge of the battery 11 is low is received with the response, the warning is displayed on the screen 12, for action. After the random code has been stored by the device 1 (overwriting anything previously stored), the device 1 acts via a step 26 to transmit the stored random code to the transponder 7, possibly in an encrypted form, and follows this in a step 27 by interrogation of the transponder 7. If the transponder 7 is still within range of the device 1, it responds by storing the received random code in its memory 10 (overwriting anything previously stored) and re-transmits it to the mobile device 1.

If the mobile device 1 does not receive the re-transmission of the random code, or the code received lacks correspondence with the random code stored by the mobile device 1, detection of this in a step 28 causes display of this error on the screen 12 of the device 1 via a step 29, and via a step 30 reversion of the device 1 to its normal operation with the transponder application closed. If on the other hand, the code received by the device 1 is determined in decision step 28 to correspond to the random code stored in the device 1, the transponder application is initiated to run in a multitasking environment via a step 31.

The transponder application continues to run with the mobile device 1 interrogating the transponder 7 periodically (for example every 5-10 seconds). While the transponder 7 remains within-range it responds by transmitting back to the device 1 a signal corresponding to the random code stored in its memory 10 for checking for correspondence with the random code stored in the mobile device 1.

The transponder set-up may be modified so that activation of this application results in the mobile device 1 transmitting a signal which interrogates the transponder 7 and to which the transponder 7 responds with a response code that is hard-wired or otherwise stored in the transponder 7. The mobile device 1 recognises and stores the code received, and proceeds to interrogate the transponder 7 repeatedly as long as the response code continues to be received in response to each interrogation.

The shutdown-protection application is a major security measure which is incorporated in the operation of the mobile device 1 with the object of preventing it from being fraudulently shutdown. The application can be started as illustrated by FIG. 3, at any time when the mobile device 1 is operational. While the application is activated, turning the device 1 off to terminate its operation (aside from termination forced automatically in the functioning of the device 1 as described later) can be brought about only if termination is initiated during a period when the device 1 is receiving response from the transponder 7. If response from the transponder 7 is not being received, termination will be effected only following the keying in via the keys 13 of an identification number or other password that has correspondence with data stored in the device 1, or following recognition by the device 1 of one or more person-identifiers (such as for example fingerprints, voice or other biometric characteristics) of the user. This requirement for turning the device 1 off to terminate its operation in the absence of transponder-response, has security advantages of a degree comparable with those associated with password-protection of initiation of operation, particularly in the circumstances of theft of the mobile device 1.

Referring to FIG. 3, the shutdown-protection application is started via a step 41 by touching the corresponding icon on the screen 12 of the mobile device 1 or through speech or key-word input to the device. The application displays in step 42 the text “shutdown protection?” on the screen 12 of the mobile device 1 and waits for a response entered either via the keys 13 or by speech input. If the response is affirmative the shutdown-protection application is activated in multitasking mode in step 43. If the response to step 42 is negative, the device 1 reverts to its normal operation without activation of the application.

It can be assumed that in the event of theft of the mobile device 1, it will be moved not only out of range of the transponder 7 but also to an extent that will bring about change of its GPS coordinates by a predetermined or prescribed amount, for example corresponding to distance of 100-200 metres, or changes of the base stations 2 with which it is in communication. The flow-diagram of FIG. 4 illustrates operation of the device 1 in this regard.

Referring to FIG. 4, while the device 1 is operating with the transponder application running at step 51, a check is made at step 52 to detect whether there is movement of the device 1 (by detecting whether there is the predetermined change of GPS coordinates and/or a base-station change, or detection by accelerometers in the mobile device 1). If no such movement is detected, operation with the transponder application at step 51 is maintained, whereas if the prescribed movement is detected, interrogation of the transponder 7 at step 53 takes place. If as a result of this the device 1 receives from the transponder 7 a response corresponding to the random code currently stored in its memory 10, and there is correspondence of this in step 54 with the code stored in the memory of the device 1, the existence of within-range communication between the device 1 and the transponder 7 has been confirmed, and the device 1 continues via step 51 to operate with the transponder application running in multitasking mode.

If, on the other hand, the device 1 in step 54 receive no response to its interrogation of the transponder 7, or there is no correspondence between the signal received and the code stored in the memory of the device 1, the transponder application causes the device 1 via step 55 to start a timer with pre-set duration (for example 20 seconds) whereafter shutdown protection is enabled if not already active at step 56. In step 57 a loud audible alarm is sounded to alert the user that the mobile device 1 has been separated from the transponder 7 (by movement away of the device 1 from the transponder 7 or vice versa). This allows the user time to shut the device 1, off if the response code is being received, or, if the code is not being received, only through correct entry within a limited number of attempts of a security-checked PIN or other password, or recognition of one or more person-identifiers submitted to the mobile device. The outcome of the procedure is checked in step 58 and provides confirmation of shutdown in step 59 when the device has been turned off in the time allocated. If, however, turning off has not been carried through within the allotted time period, the device 1 enters vis step 60 a lock-down mode that allows only a very limited sub-set of functions to be performed by the device 1.

In the lock-down mode, the shutdown-protection application is automatically activated if it is not already activated, to prevent the mobile device 1 being turned off unless the transponder 7 again comes within range or the keys 12 are operated to achieve correspondence with the stored password, or there is recognition by the device 1 of one or more person-identifiers. The facility for interrogating the transponder 7, and GPS tracking or otherwise for determining the geographic location of the device 1, as well as communication via the internet with servers 4, remain operative, but, for example, no other functions of the mobile device 1 will remain or be operative. There will therefore be a significant loss of benefit to the thief, and his/her inability to turn the device off (in the absence of the transponder 7 or cf knowledge of, or access to the relevant password or person-identifiers) will frustrate any attempt to disable its normal security features. If attempt is made to turn the device 1 off by removing its normal battery, this too will be frustrated for a limited period by the inaccessible back-up battery. Moreover, loss of battery power in any attempt to turn the device 1 off still leaves the thief unable even when restoring power, to circumvent the security of the device 1, since the current instruction address is stored in non-volatile memory. In these circumstances removing the batteries or letting them run down does not reset the program-address counter which even after re-powering will still be waiting for a response from the transponder 7 or, in the absence of that, entry of the correct password or person-identifier recognition of the user, before enabling shut-down of the device 1.

In the event of accidental loss of the device 1, normal operation of the device 1 in the transponder mode will continue while the device 1 remains within range of the transponder 7, but the form of lock-down mode in this case is only partial as compared with that described above in relation to FIG. 4, and will occur when separation from the transponder 7 takes it out of range. The procedural steps applicable to the device 1 when lost are illustrated in the flow-diagram of FIG. 5.

While the device 1 is operating with the transponder application running as represented by step 61 of FIG. 5, it will continue in that state as long as the regular periodic interrogation of the transponder 7 as represented at step 62, results in confirmation at step 63 that the transponder 7 is within range and the correct response is received. However, if there is no such confirmation at step 63, the transponder application causes the device 1 to enter the partial lock-down mode (as referred to above) at step 64. At step 64 attempts to interrogate the transponder continue repeatedly at a rate (for example every second) higher than in the regular periodic interrogations of the transponder mode, and the shutdown-protection application is automatically activated if it is not already activated.

Also in the partial lock-down mode, telephone and SMS reception are maintained as are communications with the servers 4 for derivation of GPS coordinates of the device 1, or determination of the approximate geographic location of the mobile device 1 through triangulation dependent on signals received from the base stations 2 of the cellular network the rate at which the position information is transmitted may be slowed to conserve power). Interrogation of the transponder 7 at the higher rate continues at step 62, and if the transponder 7 comes back into range and the correct response is received from it, the device 1 reverts from the partial lock-down mode to regular operation at step 61 in the transponder mode. Any missed calls or SMS messages received while the device 1 is in partial lock-down will be stored so the fact that the device has been in partial-lock down has no detrimental effect for the user.

While the device 1 is in the partial lock-down mode, the transponder application remains responsive at step 65 to determine whether there has been movement of the device 1 by detecting whether there has been a prescribed change in its GPS coordinates or there has been change of a base station 2 of the cellular wireless network with which the device 1 is in communication, or by detection of movement by accelerometers in the mobile device 1. If there has been movement of the device 1, the transponder application causes device 1 to enter the full lock-down mode at step 66, but if there has been no such movement, the device 1 continues with attempted interrogation of the transponder 7 at the higher rate at step 62 and continuation via step 64 in the partial lock-down mode.

When the device 1, having been stolen or accidentally lost, is in a lock-down or partial lock-down mode, data relevant to the geographic position or movement of the mobile device 1 is available to the servers 4 via the internet from the GPS or other facilities of the device 1 used for determining or tracking its position. After appropriate security controls, information pertaining to the specific mobile device 1 can be downloaded from the servers 4, and if this information includes position coordinates, these can be translated into a point representation on a map display on the screen 12 of the computer 5 in internet communication with the servers 4. (The transponder application may possibly be adapted to include the facility for communicating the coordinates of the present location or identity of the base stations in view, via the internet to one or other of the servers 4.)

In the circumstances in which the mobile device is running in the full lock-down mode with the shutdown-protection application activated as represented by step 70 of FIG. 6, depression of the power-off key of the device 1 detected at step 71, is ineffective to turn the device off. However, the transponder 7 will be interrogated by the shutdown-protection application at an early stage in the shutdown sequence, and if the correct response is received from the transponder 7 at step 72, the shutdown-protection application will cause the device 1 to complete the normal power-off shutdown sequence of the mobile device 1 at step 73. If no response, or an incorrect response is received from the transponder at step 72 the application will cause the text “no transponder; enter PIN” to be displayed on screen 12 at step 74 and wait at step 75 for input via keys 13 or person-identifier sensing. If the correct PIN or person-identifier has not been entered or sensed after a set number of attempts, the application will return to step 70 with the device running in lock-down with shutdown-protection activated. If the correct PIN or person-identifier is detected within a set number of attempts, the application will continue the power-off shutdown sequence (where person-identifier security based on biometric or other characteristics of the legitimate user is available for use, the display on the screen 12 and the consequential functions will be suitably adapted to this).

With the shutdown-protection application running at step 80 as shown in FIG. 7, depression of the power-off key of the device 1 detected at step 81, is ineffective to turn the device off. As in the case of the flow-diagram of FIG. 6, the attempt to turn the device off, causes the shut-down protection application to interrogate the transponder 7, and if the correct response is received and confirmed at step 82, the normal shut-down sequence of the mobile device is completed at step 83.

If no response, or an incorrect response is received from the transponder 7 at step 82 the application will cause the text “no transponder; enter PIN” to be displayed on screen 12 at step 84 and wait for input via keys 13 at step 85, or sensing of one or more authentic person-identifiers. If the correct PIN or no authentic person-identifier has been entered or sensed after a set number of attempts, the application will at step 86 ascertain whether the device 1 is in full lock-down. If it is not, step 87 causes activation of the full lock-down application and reversion to step 80 with the device 1 running with full lock-down and shut-down protection activated. If, on the other hand, the correct PIN or person-identifier is detected or sensed within a set number of attempts, the application continues with the power-off shutdown sequence at step 83 (as with the flow-diagram of FIG. 6, where person-identifier security based on biometric or other characteristics of the legitimate user is available for use, the display on the screen 12 and the consequential functions of the flow-diagram of FIG. 7, will be suitably adapted to this).

Although the present invention has been described above with reference to the drawings in the context of the mobile device 1 and a distinct transponder 7, the function of the transponder 7 can be incorporated in a second mobile device having, for example, the same, or some, of the functions as the mobile device 1. Indeed it would be possible to provide that both devices incorporate the transponder function to be interrogated for security purposes by the other, so that theft or loss of either of them could be traced.

A partial flow-diagram applicable to operation of the mobile device 1 in the situation in which the function of the transponder 7 is incorporated in a second mobile device (for example a cell phone, a tablet or a wearable device in the form of a watch or a pair of spectacles) is illustrated in FIG. 8.

Referring to FIG. 8, mobile device 1 will alert the user that the second mobile device may have been lost or stolen, in the event that step 90 (which corresponds to step 54 in FIG. 4 or step 63 in FIG. 5) detects loss of communication with the transponder of the second device. An audible alarm of the device 1 will sound at step 91, and an appropriate text will be displayed on the screen 12 via step 92 during, say, 60 seconds before proceeding to step 93. Step 93 corresponds to step 55 in the flow-diagram of FIG. 4 and step 64 in the flow-diagram of FIG. 5.

It is possible for the transponder application and the shutdown-protection application to be downloaded into an existing mobile device, or incorporated ab initio into the device. Although the shutdown-protection application may be utilised separately from the transponder application, its major benefit against theft and loss, is realised where there is activation in the device of a GPS-tracking application and/or cellular or other wireless communication with base stations from which the geographic position of the device can be tracked with reasonable accuracy.

The transponder application may similarly be utilised separately from the shutdown-protection application, but the greatest benefit results from their use together.

1-32. (canceled)

33. A method of affording security to a mobile device, wherein a code-transmitting unit and the mobile device are independently movable relative to one another, and the code-transmitting unit is operative to transmit a code repeatedly for reception by the mobile device subject to limitation of transmission range from the code-transmitting unit to the mobile device, and functioning of the mobile device is modified in the event that the transmitted code is not being received by the mobile device,
wherein one or more operations of the mobile device are inhibited, initiated or supported in response to whether or not movement of the mobile device is detected in conjunction with detection that the transmitted code is not being received by the mobile device.

34. The method according to claim 33, further comprising forming the code-transmitting unit as part of a transponder and the transmitted code is derived from a signal received by the transponder from the mobile device to interrogate the transponder repeatedly, and operating the transponder to transmit the code for reception by the mobile device in response to each successive interrogation of the transponder by the mobile device.

35. The method according to claim 33, further comprising turning of the mobile device off in respect of some of its operations is inhibited in the event that the transmitted code is not received by the mobile device.

36. The method according to claim 35, further comprising, in the event that the transmitted code is not received by the mobile device, initiating operations of the mobile device from which its geographical location can be determined or tracked if not already operative, and turning off of such operations whether initiated as aforesaid or already operative is inhibited.

37. The method according to claim 33, further comprising, in the event that movement of the mobile device is detected and the transmitted code is not received by the mobile device, operating the mobile device in a mode in which operation of the mobile device is limited as compared with its installed performance capability and as such to include operations of the mobile device from which its geographical location can be determined or tracked.

38. The method according to claim 33, further comprising, in the event that the transmitted code is not received by the mobile device and movement of the mobile device is not detected, operating the mobile device in a partial lock-down mode in which operation of the mobile device is limited to allowing performance of only a sub-set of the functions for which it has installed performance capability, the sub-set including operations of the mobile device from which its geographical location can be determined or tracked.

39. The method according to claim 33, further comprising providing the mobile device with a normal operating mode in which it is operable in all functions for which it has installed performance capability, and a full lock-down mode in which operation of the mobile device is limited to allowing performance of operations of the mobile device from which its geographical location can be determined or tracked and only some other or others of the functions of the sub-set, and whether the mobile device is operating in the normal operating mode or the partial lock-down mode, it enters the full lock-down mode of operation in the event that movement of the mobile device is detected while the transmitted code is not being received by the mobile device.

40. The method according to claim 39, further comprising, while the mobile device is operating in the full lock-down mode, it is operable or operative in only (a) a function of GPS tracking and/or other facility of the mobile device that enables the geographical location of the mobile device to be determined or tracked, (b) a function for checking whether a password keyed or otherwise entered into the mobile device is accepted by the mobile device as correct, and/or the mobile device recognizes as authentic one or more person-identifiers submitted to it, (c) a facility for interrogating the code-transmitting unit, and (d) a facility for communication with servers via the internet.

41. The method according to claim 38, further comprising limiting the sub-set of functions to which performance of the mobile device in the partial lock-down mode to (a) a function of receiving incoming calls, (b) a function of receiving incoming SMS or other messages, (c) a function of checking whether the transmitted code is received, (d) a function of GPS tracking and/or other facility of the mobile device that enables the geographical location of the mobile device to be determined or tracked, (e) a function of detecting movement of the mobile device, and (f) a function of checking whether a password keyed or otherwise entered into the mobile device is accepted by the mobile device as correct, and/or the mobile device recognizes as authentic one or more person-identifiers submitted to it.

42. The method according to claim 38, further comprising, if the transmitted code is received by the mobile device while the mobile device is operating in the partial lock-down mode, restoring operability of the mobile device in all functions for which it has installed performance capability.

43. The method according to claim 33, wherein the mobile device responds to action attempting to turn off power supply within the mobile device, by checking whether the transmitted code is being received by the mobile device, and only if it is being received, to turn off the power supply within the mobile device.

44. The method according to claim 33, wherein in the event that the transmitted code is not being received by the mobile device, power supply within the mobile device is turned off only in the event that a password keyed or otherwise entered into the mobile device is accepted by the mobile device as correct, and/or the mobile device recognizes as authentic one or more person-identifiers submitted to it.

45. The method according to claim 33, further comprising adapting the mobile device for two-way communication in a cellular wireless communications network.

46. The method according to claim 33, further comprising carrying the code-transmitting unit on the person of a user of the mobile device.

47. A security system comprising a mobile device and a code-transmitting unit that are movable independently of one another, wherein the system is operable according to the method of claim 33.

48. A security system comprising a mobile device and a code-transmitting unit that are movable independently of one another, in which the code-transmitting unit is operable to transmit a code repeatedly for reception by the mobile device subject to limitation of transmission range from the code-transmitting unit to the mobile device, and in which functioning of the mobile device is modified in the event that the transmitted code is not being received by the mobile device, wherein selectively one or more operations of the mobile device are inhibited, initiated or supported in response to whether or not movement of the mobile device is detected in conjunction with detection that the transmitted code is not being received by the mobile device.

49. The security system according to claim 48, wherein the code-transmitting unit is part of a transponder, and the transmitted code is derived from a signal received by the transponder from the mobile device to interrogate the transponder repeatedly, and the transponder is operative to transmit the code for reception by the mobile device in response to each successive interrogation of the transponder by the mobile device.

50. The security system according to claim 49, wherein in the event that movement of the mobile device is detected and the transmitted code is not received by the mobile device, the mobile device operates in a mode in which operation of the mobile device is limited as compared with its installed performance capability and as such to include operations of the mobile device from which its geographical location can be determined or tracked.

51. The security system according to claim 48, wherein in the event that the transmitted code is not received by the mobile device and movement is not detected, the mobile device operates in a partial lock-down mode in which operation of the mobile device is limited to allowing performance of only a sub-set of the functions for which it has installed performance capability, the sub-set including operations of the mobile device from which its geographical location can be determined or tracked.

52. The security system according to claim 51 wherein the mobile device has a normal operating mode in which it is operable in all functions for which it has installed performance capability, and a full lock-down mode in which operation of the mobile device is limited to allowing performance of operations of the mobile device from which its geographical location can be determined or tracked and selectively only some other or others of the functions of the sub-set, and wherein whether the mobile device is operating in the normal operating mode or the partial lock-down mode, it enters the full lock-down mode of operation in the event that movement of the mobile device is detected while the transmitted code is not being received by the mobile device.

53. The security system according to claim 52, wherein while the mobile device is operating in the full lock-down mode it is selectively operable or operative in (a) a function of GPS tracking and/or other facility of the mobile device that enables the geographical location of the mobile device to be selectively determined or tracked, (b) a function for checking whether a password keyed or otherwise entered into the mobile device is accepted by the mobile device as correct, and/or the mobile device recognizes as authentic selectively one or more person-identifiers submitted to it, (c) a facility for interrogating the code-transmitting unit, and (d) a facility for communication with servers via the Internet.

54. The security system according to claim 53, wherein while the mobile device is operating in the partial lock-down mode the mobile device responds to movement of the mobile device to enter the full lock-down mode of operation.
